(19) United States
(12) Patent Application Publication
(10) Pub. No.: US 2025/0111999 A1
(43) Pub. Date: Apr. 3, 2025

(54) SWITCH ASSEMBLIES USING POGO PINS AND ASSOCIATED SYSTEMS AND METHODS

(71) Applicant: Mason Electric Co., Sylmar, CA (US)

(72) Inventor: Glen M. Ennis, Castaic, CA (US)

(21) Appl. No.: 18/895,250

(22) Filed: Sep. 24, 2024

Related U.S. Application Data
(60) Provisional application No. 63/586,385, filed on Sep. 28, 2023.

(51) Int. Cl. H01H 1/06

(52) U.S. Cl. CPC H01H 1/06

(57) ABSTRACT

The present disclosure provides a switch assembly that can selectively close or open an electrical circuit. In some embodiments, a switch assembly includes a first board, a plurality of contact pads, a second board, and a plurality of pairs of pogo pins. At least one of the first or second board can be movable relative to the other to configure the switch assembly between an off state and an on state. Each pair of pogo pins can include first end portions electrically coupled to an open circuit and second end portions opposite the first end portions. In the off state, the second end portions of each pair are configured to not be in contact with any of the contact pads. In the on state, the second end portions of each pair are configured to be in contact with a corresponding one of the contact pads, thereby closing the open circuit.

### CROSS-REFERENCE TO RELATED APPLICATION(S)

The present application claims priority to and the benefit of U.S. Provisional Patent Application No. 63/586,385, filed Sep. 28, 2023, the disclosure of which is incorporated herein by reference in its entirety.

### TECHNICAL FIELD

The present disclosure relates to switch assemblies, and more particularly to switch assemblies using pogo pins.

### BACKGROUND

Conventional switches for electrical circuits include bulky components, such as buss bars and rotor fingers, that take up a relatively large amount of space. Due to their sizing constraints, adding additional components for redundancy is often not a desirable option. Moreover, the mechanical and electrical components of conventional switches must be robust and durable enough to maintain a suitable operational lifespan. Moreover, different switch applications may require different sets of components, which can strain resource availability and manufacturing capacity.

### SUMMARY

The technology of the present disclosure overcomes drawbacks of conventional technology and provides additional benefits. The switch assemblies in accordance with the present technology are self-contained units that can easily be coupled to, integrated with, and/or swapped between various electrical devices. The switch assemblies described herein also have relatively small footprints, require relatively small movement of a single component for alignment of parts, and provide various degrees of redundancy. For example, one or more embodiments of the present technology provide a switch assembly that includes a first board, a plurality of contact pads attached to and exposed on the first board, a second board spaced apart from the first board, and a plurality of pairs of pogo pins attached to the second board. At least one of the first board or the second board can be movable relative to the other to configure the switch assembly between an off state and an on state. Each pair of pogo pins can include first end portions configured to be electrically coupled to an open circuit, and second end portions opposite the first end portions. In the off state, the second end portions of each pair of pogo pins are configured to not be in contact with any of the contact pads. In the on state, the second end portions of each pair of pogo pins are configured to be in contact with a corresponding one of the contact pads, thereby closing the open circuit.

In some embodiments, a switch assembly includes a plurality of board pieces each independently movable relative to one another, a plurality of contact pads attached to and exposed on the plurality of board pieces, a board spaced apart from the plurality of board pieces, and a plurality of pairs of pogo pins attached to the board. At least one of the plurality of board pieces or the board can be movable toward or away from the other. Each pair of pogo pins can include first end portions configured to be electrically coupled to an open circuit, and second end portions opposite the first end portions. The switch assembly can be, for each of the board pieces, configurable between (i) an off state in which none of the pogo pins make contact with the contact pads, (ii) a first partially on state in which a first subset of the pogo pins make contact with corresponding ones of the contact pads, and (iii) a second partially on state in which a second subset of the pogo pins make contact with corresponding ones of the contact pads.

In some embodiments, a switch assembly has a first board, a plurality of contact pads attached to and exposed on the first board, a plurality of connection terminals, a second board spaced apart from the first board, and a plurality of pogo pins attached to the second board and electrically coupled to one another. The plurality of contact pads can include a first contact pad, a second contact pad, and a third contact pad. The plurality of connection terminals can include a first connection terminal electrically coupled to the first contact pad, a second connection terminal electrically coupled to the second contact pad, wherein the first and second connection terminals are configured to be electrically coupled to a first open circuit, and a third connection terminal electrically coupled to the third contact pad, wherein the first and third connection terminals are configured to be electrically coupled to a second open circuit. The second board can be rotatable relative to the first board. The plurality of pogo pins can include a first pogo pin configured to remain in contact with the first contact pad as the second board rotates relative to the first board, and a second pogo pin configured to move into and out of contact with the second or third contact pad as the second board rotates relative to the first board.

In some embodiments, a switch assembly includes a first board, a plurality of contact pads attached to and exposed on the first board, a plurality of output terminals, a second board spaced apart from the first board, a plurality of pogo pins attached to the second board and electrically coupled to one another, and a processor coupled to the plurality of output terminals. The plurality of contact pads can include a first contact pad, a second contact pad, and a third contact pad. The plurality of output terminals can include a first output terminal electrically coupled to the first contact pad, a second output terminal electrically coupled to the second contact pad, and a third output terminal electrically coupled to the third contact pad. The second board can be movable relative to the first board. The plurality of pogo pins can include a first pogo pin configured to remain in contact with the first contact pad as the second board moves relative to the first board, a second pogo pin configured to move into and out of contact with the second contact pad as the second board moves relative to the first board, and a third pogo pin configured to move into and out of contact with the third contact pad as the second board moves relative to the first board. The processor can be configured to generate a binary code output based at least in part on whether current is flowing through the second and/or third pogo pins.

### BRIEF DESCRIPTION OF THE DRAWINGS

A better understanding of the features and advantages of the present disclosure will be obtained by reference to the following detailed description that sets forth illustrative embodiments, in which the principles of the disclosure are utilized, and the accompanying drawings, seen in FIG. 1-12D. In these figures, switch motion (linearly, rotational, or axially) used to make and break electrical connection is represented by A1, A2, A3, A4, A5, A6, A7.

FIG. 1 is a schematic diagram illustrating a device switch circuit in accordance with embodiments of the present technology.

FIGS. 2A and 2B are perspective views of a double redundancy switch assembly in accordance with embodiments of the present technology.

FIGS. 3A and 3B are perspective views of a triple redundancy switch assembly in accordance with embodiments of the present technology.

FIGS. 4A and 4B are perspective views of another double redundancy switch assembly in accordance with embodiments of the present technology.

FIGS. 5A and 5B are perspective views of another triple redundancy switch assembly in accordance with embodiments of the present technology.

FIG. 5C is a partially cut-away side elevation view of a push-type triple redundancy switch assembly in accordance with embodiments of the present technology.

FIGS. 6A and 6B are perspective views of a quadruple redundancy rotary switch assembly in accordance with embodiments of the present technology.

FIGS. 7A and 7B are perspective views of a sextuple redundancy rotary switch assembly in accordance with embodiments of the present technology.

FIGS. 8A-8C are perspective views of a dual-axis redundancy switch assembly in accordance with embodiments of the present technology.

FIGS. 9A-9F illustrate a multi-directional sliding switch assembly in accordance with embodiments of the present technology.

FIGS. 10A and 10B are rear and front perspective views, respectively, of a multi-positional rotary switch assembly in accordance with embodiments of the present technology.

FIGS. 11A-11C illustrate operation of the multi-positional rotary switch assembly of FIG. 10A in accordance with embodiments of the present technology.

FIGS. 12A-12D are plan views of a binary code rotary switch assembly in accordance with embodiments of the present technology.

A person skilled in the relevant art will understand that the features shown in the drawings are for purposes of illustrations, and variations, including different and/or additional features and arrangements thereof, are possible.

### DETAILED DESCRIPTION

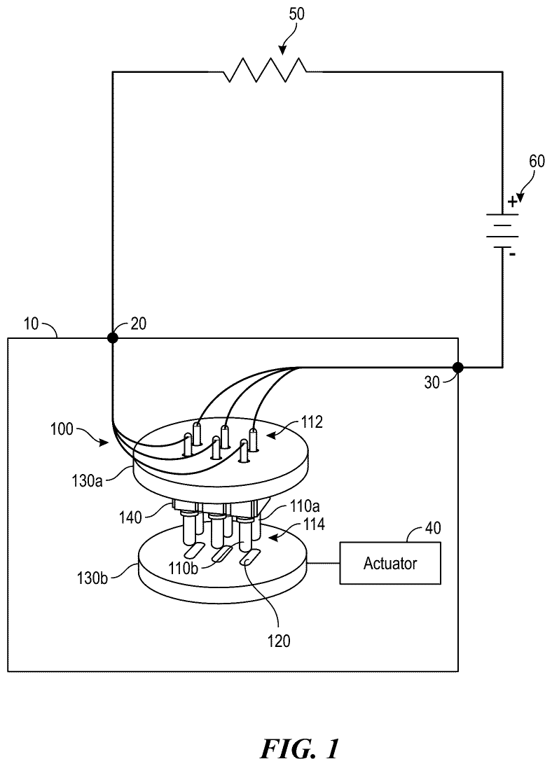

The present technology is directed to switch assemblies using pogo pins. Specific details of the present technology are described herein with respect to FIGS. 1-12D. Although many of the embodiments are described with respect to electrical switch assemblies and systems, it should be noted that other applications and embodiments in addition to those disclosed herein are within the scope of the present technology. Further, embodiments of the present technology can have different configurations, components, and/or procedures than those shown or described herein. Moreover, a person of ordinary skill in the art will understand that embodiments of the present technology can have configurations, components, and/or procedures in addition to those shown or described herein and that these and other embodiments can be without several of the configurations, components, and/or procedures shown or described herein without deviating from the present technology.

While various embodiments of the present technology are shown and described herein, it will be obvious to those skilled in the art that such embodiments are provided by way of example only. Numerous variations, changes, and substitutions may occur to those skilled in the art without departing from the scope of the present technology. It should be understood that various alternatives to the embodiments described herein may be employed. Further, components disclosed in connection with one or more of the described embodiments may be included or usable in or with other embodiments even if not specifically shown or described. Some components described or shown in connection with an embodiment may not be required and may be excluded while still being within the scope of the applicant's inventive technology.

In some embodiments, a switch assembly includes at least one pair of pogo pins configured to engage and disengage at least one contact pad to open or close an electrical circuit. The pogo pins can be connected to two ends of an electrical circuit, such that, when the pogo pins are not in contact with the contact pad, the pogo pins create an open circuit and the switch assembly is in an OFF state. The pogo pins and the contact pad can be moved relative to one another into contact, such that the contact pad creates an electrical path between the two pogo pins and the switch assembly is in an ON state. In some embodiments, the pogo pins and the contact pad can be moved laterally in a direction parallel to the surface of the contact pad. In some embodiments, the pogo pins can be moved in a direction parallel to the pogo pins' lengths. In some embodiments, the pogo pins and/or the contact pads can be rotated into and out of contact. The pogo pins can include ball points and/or spring-loaded pogo pins to assist with maintaining electrical contact during such movements.

In some embodiments, the switch assembly can have more contact pads than pairs of pogo pins to define multiple ON states. For example, one pair of pogo pins can be moved (e.g., rotated) relative to multiple different contact pads, each defining an ON state when in contact with the respective contact pad. The angles of rotation of the pair of pogo pins defining the ON and OFF states can be designed to fit the particular switch application.

Embodiments of the present technology provide a switch assembly including at least one pair of pogo pins and at least one contact pad. The pair of pogo pins can be coupled to components of an electrical circuit. The pair of pogo pins and/or the contact pad can be moved toward or away from each other by an external force, such as an automated or a human-exerted force. When the pair of pogo pins and the contact pad are in contact, current can flow from one of the pogo pins, through the contact pad, and out through the other pogo pin to complete the electrical circuit. When the pair of pogo pins and the contact pad are not in contact, current cannot flow between the pair of pogo pins, resulting in an open circuit. In some embodiments, the number of the contact pads is equal to the number of the pairs of pogo pins.

In some embodiments, the pair of pogo pins and/or the contact pad can be moved relative to one another in various directions or motions. In one example, the pair of pogo pins and/or the contact pad can be moved along a direction parallel to a plane on which the contact pad extends. In another example, the pair of pogo pins and/or the contact pad can be moved along a direction parallel to the axes on which the pogo pins extend. In yet another example, the pair of pogo pins and/or the contact pad can be moved relative to each other in a rotational motion. The pair of pogo pins can include ball points and/or compression springs to assist with movement relative to the contact pad and reduce wear or damage to the switch assembly.

In some embodiments, the switch assembly can provide various degrees of redundancy by having multiple pairs of pogo pins and multiple contact pads, each corresponding to a pair of pogo pins. The multiple pairs of pogo pins can be coupled between selected portions of an electrical circuit in parallel, such that the circuit is completed as long as one of the pairs of pogo pins and the contact pad are in proper contact. In some embodiments, the switch assembly can include multiple redundancies to ensure that motion of the pair of pogo pins and/or the contact pad completes the electrical circuit as intended. For example, the switch assembly can include two or more pairs of pogo pins and two or more corresponding pogo pins. When an external force is applied, all of the pairs of pogo pins and/or all of the contact pads can toward one another, and the electrical circuit can be completed when at least one of the pairs of pogo pins makes contact with a corresponding one of the contact pads.

In some embodiments, the switch assembly can be coupled to a processor that generates binary code outputs based on readings from the switch assembly. For example, the switch assembly can include a plurality of pogo pins configured to move together, and a plurality of contact pads arranged in various patterns. The processor can determine whether a particular contact pad is in contact with any of the pogo pins, and if so, generates a binary output of “1”, and if not, generates a binary output of “0”. By having multiple contact pads in a predetermined arrangement, particular positions or orientations of the pogo pins can correspond to particular string of binary outputs. In some embodiments, pogo pins and contact pads can be arranged such that depending on their relative positions, a different binary code output is generated. For example, the pogo pins and/or the contact pads can be moved relative to one another in a rotary motion such that different relative angles of the rotary motion results in different binary code outputs.

FIG. 1 is a schematic diagram illustrating a switch assembly 100 couplable to a device 50 (represented schematically by a resistor symbol) and a power source 60 (represented schematically as a battery). As described further herein, the switch assembly 100 can be operated to turn on and off the device 50 or portions of the device. The device 50 can include any electrical device used in a variety of fields, including but not limited to aerospace, automotive, marine, defense, space, clean energy, commercial, etc. The switch assembly 100 can include a housing 10 that protects and/or ensures proper actuation of the switch assembly 100.

In the illustrated embodiment, the switch assembly 100 includes a plurality of electrically conductive pogo pins 110, a first board 130a with apertures configured to receive and support the pogo pins 110, a second board 130b with apertures or recesses configured to receive and support a plurality of electrically conductive contact pads 120, and an optional support member 140 configured to mechanically support and ensure electrical isolation between the pogo pins 110. Each of the first and second boards 130a, 130b and the support member 140 can be made from a non-conductive material, such as plastic or printed circuit board (PCB) materials (e.g., glass epoxy, cotton paper impregnated with phenolic resin).

The pogo pins 110 can be arranged in pairs, each including a first pogo pin 110a and a second pogo pin 110b, and each pair of pogo pins 110 can be positioned to electrically engage one of the contact pads 120. In some embodiments, the switch assembly 100 includes a single pair of pogo pins 110. In some embodiments, the switch assembly 100 includes multiple pairs of pogo pins 110, providing redundancy, as will be described in further detail below. Each pogo pin 110 can include opposing first and second end portions 112 and 114. The first end portions 112 can extend through the first board 130a and electrically connect to electrical leads or wiring coupled to the device 50 and the power source 60. Specifically, the first pogo pins 110a of each pair can be coupled to one side of the circuit (e.g., coupled to the power source 60 in parallel), and the second pogo pins 110b of each pair can be coupled to the other side of the circuit (e.g., coupled to the device 50 in parallel). In some embodiments, the first end portions 112 are coupled to the device 50 and the power source 60 via first and second connection ports 20, 30 included in the housing 10. The first and second connection ports 20, 30 can allow the housing 10, and thus the switch assembly 100, to be connected to and swapped between various devices 50 with ease. The second end portion 114 can be positioned to move into engagement with the contact pad 120.

As will be described in greater detail below, the first board 130a and/or the second board 130b can be moved relative to each other, such as laterally, axially, radially, etc., toward or away from one another, so that the pogo pins 110 come into and out of contact with the contact pads 120 to complete or open the circuit, respectively. In some embodiments, the first board 130a with the pogo pins 110 can be configured to remain stationary while the second board 130b with the contact pads 120 is moved. This arrangement can reduce the movement of wired components within the switch assembly, so as to effectively increase the operational lifespan of the switch assembly 100. This is because the wires connecting the first end portions 112 to the device 50 and the power 60 (and the first and second connection ports 20, 30 of the housing 10) can remain stationery with the first board 130a, reducing wear and the risk of the wires disconnecting. In some embodiments, an actuator 40 is included within or on the housing 10, and is operably coupled to the second board 130b. The actuator 40 can be controlled manually or automatically to actuate the switch assembly 100 by moving the second board 130b such that the pogo pins 110 come into and out of contact with the contact pads 120 as desired. In some embodiments, the assembly 100 can further include a détente configured to provide tactile feedback (e.g., a snap) to a user to indicate that the assembly 100 has switched between the ON and OFF states.

The switch assembly 100 in the illustrated embodiment is a self-contained unit that can be easily and securely coupled to and swapped between various electrical devices. The switch assembly 100 also has a relatively small form factor and requires minimal movement of a single component (e.g., the second board 130b) to align the pogo pins and the contact pads, allowing for a smaller switch package that can be used in a wide array of applications. The smaller footprint also allows space for various degrees of redundancy. Moreover, the use of pogo pins in a switching mechanism, as opposed to in a connecting mechanism, provides a unique application that takes advantage of the ability of pogo pins to compress and/or roll across surfaces in order to create a switch with a long operational lifespan.

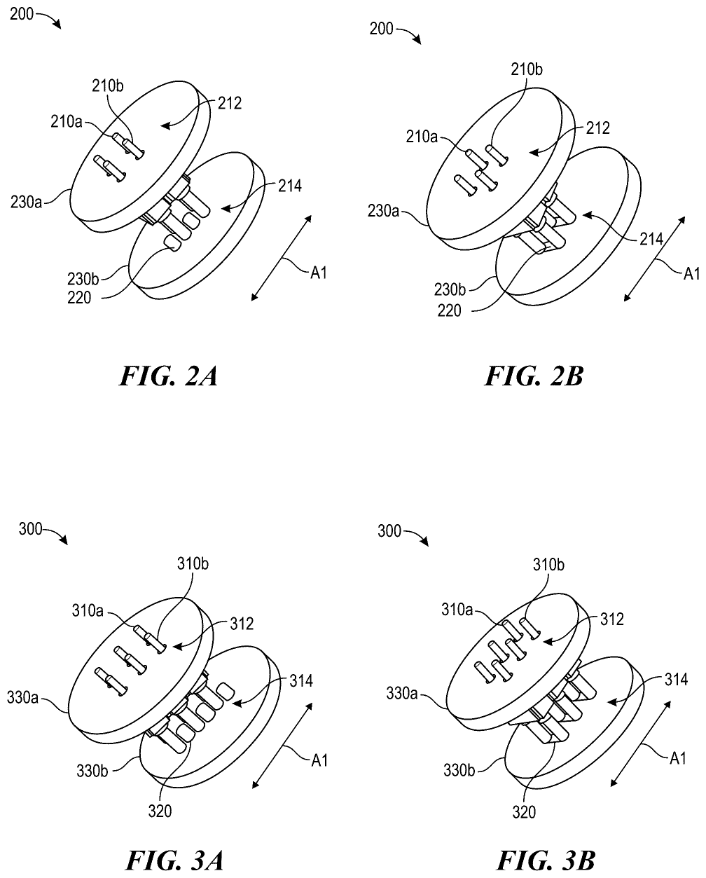

FIGS. 2A-3B illustrate linear motion switch assemblies with varying degrees of redundancy in accordance with embodiments of the present technology. More specifically, FIGS. 2A and 2B are perspective views of a double redundancy linear switch assembly 200 (“assembly 200”) in an OFF state and an ON state, respectively, and FIGS. 3A and 3B are perspective views of a triple redundancy linear switch assembly 300 (“assembly 300”) in an OFF state and an ON state, respectively. The assemblies 200, 300 can be examples of the switch assembly 100 illustrated in and described above with respect to FIG. 1. The illustrated linear motion switch assemblies are self-contained units that require little movement for operation, allowing the assemblies to be particularly advantageous in applications in which minimal motions in a linear direction for actuation are desirable (e.g., a dual redundant toggle or slide switch).

Referring first to FIGS. 2A and 2B, the assembly 200 includes a first board 230a, two pairs of pogo pins 210 fixed to the first board 230a, a second board 230b, and two contact pads 220 fixed to the second board 230b. As discussed further herein, the first board 230a and/or the second board 230b are movable in a lateral direction. Each pair of pogo pins 210 includes a first pogo pin 210a and a second pogo pin 210b spaced apart from the first pogo pin 210a. Each pogo pin 210 can include a first end portion 212 configured to be electrically coupled to the rest of a circuit (e.g., as shown in FIG. 1) and a second end portion 214 opposite the first end portion 212. Each of the first board 230a and the second board 230b can be composed of epoxy, plastics, and/or other suitable insulating materials.

Referring next to FIGS. 3A and 3B, the assembly 300 includes a first board 330a, three pairs of pogo pins 310 fixed to the first board 330a, a second board 330b, and three contact pads 320 attached to and exposed on the second board 330b. As discussed further herein, the first board 330a and/or the second board 330b are movable in a lateral direction. Each pair of pogo pins 310 includes a first pogo pin 310a and a second pogo pin 310b spaced apart from the first pogo pin 310a. Each pogo pin 310 can include a first end portion 312 configured to be electrically coupled to the rest of a circuit (e.g., as shown in FIG. 1) and a second end portion 314 opposite the first end portion 312 (e.g., a triple redundant toggle or slide switch). Each of the first board 330a and the second board 330b can be composed of epoxy, plastics, and/or other suitable insulating materials.

Referring to FIGS. 2A-3B together, during operation, the assemblies 200, 300 can move between the OFF state (FIGS. 2A and 3A) and the ON state (FIGS. 2B and 3B) by moving the first board 230a, 330a and/or the second board 230b, 330b substantially along axis A1 (e.g., laterally such that the pogo pins 210, 310 slide along the surface of the second board 230b, 330b). In the OFF state, the second end portions 214, 314 of the pogo pins 210, 310 are not in electrical contact with the corresponding ones of the contact pads 220, 330, but are instead in contact with the second board 230b, 330b. As previously mentioned, the first and second boards 230a, 230b, 330a, 330b can be made from an insulating or non-conductive material such that when the assemblies 200, 300 are in the OFF state, current does not flow between the first pogo pin 210a, 310a and the second pogo pin 210b, 310b of each pair, resulting in an open circuit. In the ON state, the second end portions 214, 314 of the pogo pins 210, 310 are in contact with corresponding ones of the contact pads 220, 320, resulting in a closed circuit that allows current to flow between the first pogo pins 210a, 310a and the second pogo pins 210b, 310b of each pair through the contact pad 220, 320. In some embodiments, individual ones of the pogo pins 210, 310 can include spring-loaded ball point pogo pins to allow easier movement of the second end portion 214, 314.

The double redundancy switch assembly 200 with the two pairs of pogo pins 210 and the triple redundancy switch assembly 300 with the three pairs of pogo pins 310 provide potential back up configurations to ensure completion of the electrical circuit when the assemblies 200, 300 are in the ON state in the event that an element of the assemblies 200, 300 is compromised. As illustrated in FIG. 1, the pairs of pogo pins 210 can be coupled to the rest of the electrical circuit in parallel such that as long as at least one pair of pogo pins 210, 310 properly contacts the corresponding contact pad 220, 320, current can flow across the assemblies 200, 300 when in the ON state. Although more components are required for the assembly 300 compared to the assembly 200, the higher degree of redundancy can be more desirable in certain applications. A person skilled in the art will appreciate that a switch assembly in accordance with the present technology can include any number pairs of pogo pins and contact pads to provide any degree of redundancy, and can include the pogo pins and contact pads in different arrangements.

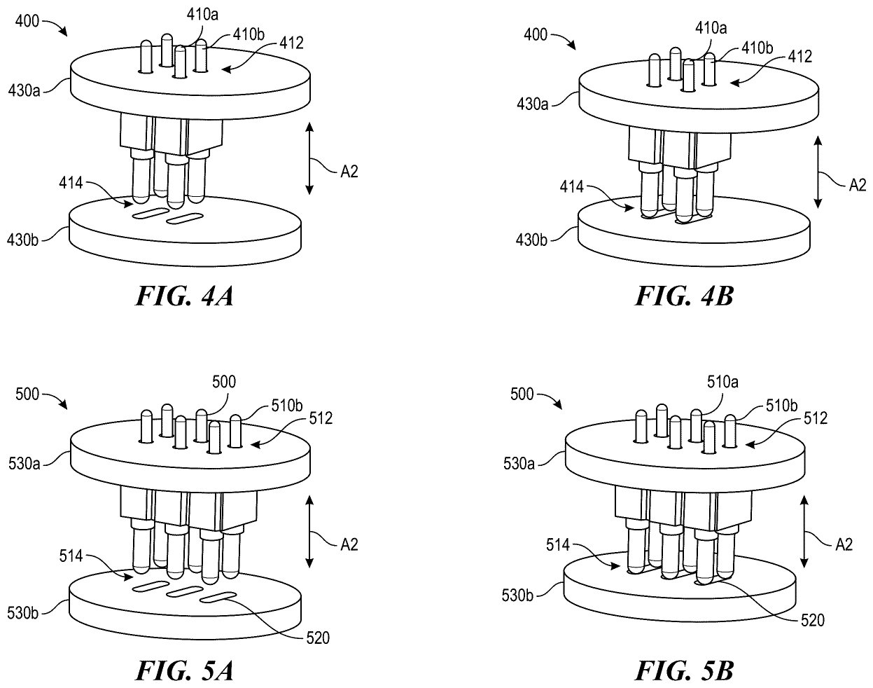

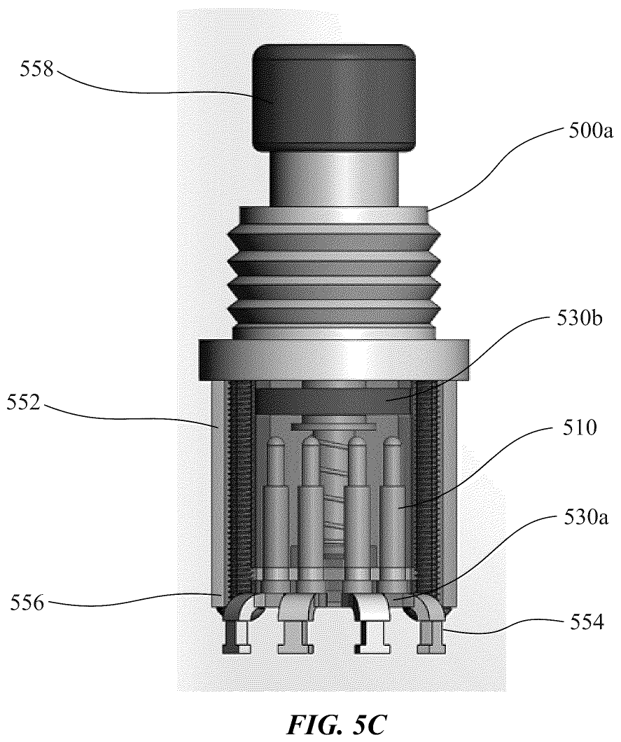

FIGS. 4A-5B illustrate push or axial motion switch assemblies with varying degrees of redundancy in accordance with embodiments of the present technology. More specifically, FIGS. 4A and 4B are perspective views of a double redundancy axial switch assembly 400 (“assembly 400”) in an OFF state and an ON state, respectively, and FIGS. 5A and 5B are perspective views of a triple redundancy axial switch assembly 500 (“assembly 500”) in an OFF state and an ON state, respectively. The assemblies 400, 500 can be examples of the switch assembly 100 illustrated in and described above with respect to FIG. 1. The illustrated axial motion switch assemblies are self-contained units that require little movement for operation, allowing the assemblies to be particularly advantageous in applications in which minimal motions in an axial direction for actuation are desirable (e.g., dual and triple redundant pushbutton switches).

Referring first to FIGS. 4A and 4B, the assembly 400 is a push-type switch that includes a first board 430a, two pairs of pogo pins 410 fixed to the first board 430a, a second board 430b, and two contact pads 420 attached to and exposed on the second board 430b. As discussed further herein, the first board 430a and/or the second board 430b are movable toward or away from the other in a direction substantially parallel to the axes of the pogo pins 410. Each pair of pogo pins 410 includes a first pogo pin 410a and a second pogo pin 410b spaced apart from the first pogo pin 410a. Each pogo pin 410 can include a first end portion 412 configured to be electrically coupled to the rest of a circuit (e.g., as shown in FIG. 1) and a second end portion 414 opposite the first end portion 412. Each of the first board 430a and the second board 430b can be composed of epoxy, plastics, and/or other suitable insulating materials.

Referring next to FIGS. 5A and 5B, the assembly 500 is also a push-type switch that includes a first board 530a, three pairs of pogo pins 510 fixed to the first board 530a, a second board 530b, and three contact pads 520 attached to and exposed on the second board 530b. As discussed further herein, the first board 530a and/or the second board 530b are movable toward or away from the other in a direction substantially parallel to the axes of the pogo pins 510. Each pair of pogo pins 510 includes a first pogo pin 510a and a second pogo pin 510b spaced apart from the first pogo pin 510a. Each pogo pin 510 can include a first end portion 512 configured to be electrically coupled to the rest of a circuit (e.g., as shown in FIG. 1) and a second end portion 514 opposite the first end portion 512. Each of the first board 530a and the second board 530b can be composed of epoxy, plastics, and/or other suitable insulating materials.

Referring to FIGS. 4A-5B together, during operation, the assemblies 400, 500 can move between the OFF state (FIGS. 4A and 5A) and the ON state (FIGS. 4B and 5B) by moving the first board 430a, 530a and/or the second board 430b, 530b substantially along axis A2 toward or away from the other (e.g., vertically such that the pogo pins 210, 310 move axially towards or away from the second board 230b, 330b). In the OFF state, the second end portions 414, 514 of the pogo pins 410, 510 are not in electrical contact with the corresponding ones of the contact pads 420, 530, but are instead spaced apart from the second board 430b, 530b to define a gap therebetween, resulting in an open circuit. However, the pogo pins 410, 510 may be laterally aligned with the corresponding ones of the contact pads 520 such that only axial motion along the axis A2 is required to switch to the ON state. In the ON state, the second end portions 414, 514 of the pogo pins 410, 510 are in contact with corresponding ones of the contact pads 420, 520, resulting in a closed circuit that allows current to flow between the first pogo pins 410a, 510a and the second pogo pins 410b, 510b of each pair through the corresponding contact pad 420, 520. In some embodiments, individual ones of the pogo pins 410, 510 can include spring loaded pogo pins to allow the pogo pins 410, 510 to compress as needed when pushed into contact with the contact pads 420, 520 to avoid damage.

FIG. 5C illustrates an example of a push-type switch assembly 500a with the three pairs of pogo pins 510 contained in the switch body 552 and fixed to the first board 530a. The pogo pins 510 are attached to connector leads 554 exposed at a bottom end 556 of the body 552. The second board 530b with the contact pads 520 (FIG. 5A) is coupled to a push actuator 558 that moves axially relative to the switch body 552 so as to move the second board 530b in a direction substantially parallel to the axes of the pogo pins 510. The push actuator 558 can be engaged and pushed by a user to move the second board 530b into or out of electrical engagement with the pogo pins 510, so as to move the push-type switch assembly 500a between the OFF state (as shown in FIG. 5C) and the ON state. The switch assembly 500a can include a spring or other biasing member coupled to the push actuator 558 and the second board 530b to urge the board, for example, toward the OFF state and out of engagement with the pogo pins 510. Other embodiments can be configured so the switch assembly is biased toward the ON state.

As discussed above with reference to the assemblies 200, 300, the assemblies 400, 500 provide double and triple redundancy, respectively, to reduce the likelihood that the assemblies 400, 500 fail to complete the circuit when in the ON state.

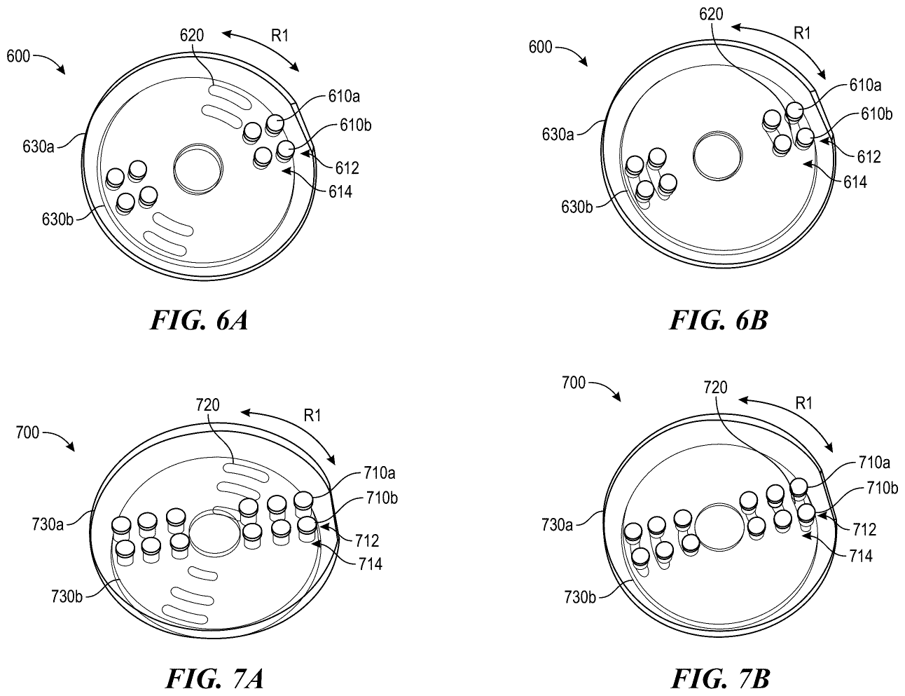

FIGS. 6A-7B illustrate rotational motion switch assemblies with varying degrees of redundancy in accordance with embodiments of the present technology. More specifically, FIGS. 6A and 6B are perspective views of a quadruple redundancy rotary switch assembly 600 (“assembly 600”) in an OFF state and an ON state, respectively, and FIGS. 7A and 7B are perspective views of a sextuple redundancy rotary switch assembly 700 (“assembly 700”). The assemblies 600, 700 can be examples of the switch assembly 100 illustrated in and described above with respect to FIG. 1. The rotational motion switch assemblies illustrated and described herein are self-contained units that occupy a constant and relatively small volume during operation, allowing the assemblies to be particularly advantageous in applications in which motions in a rotational direction, rather than in a linear direction, for actuation are desirable (e.g., dual and triple redundant rotary switches).

Referring first to FIGS. 6A and 6B, the assembly 600 includes a first board 630a, four pairs of pogo pins 610 fixed to the first board 630a, a second board 630b, and four contact pads 620 attached to and exposed on the second board 630b. The first board 630a and the second board 630b can comprise concentric, generally circular boards made of epoxy, plastics, and/or other suitable insulating materials. Two of the four pairs of the pogo pins 610 are attached to one side of the first board 630a and the remaining two pairs of the pogo pins 610 are attached to an opposite side of the first board 630b. Similarly, two of the four contact pads 620 are attached to one side of the second board 630b and the remaining two contact pads 620 are attached to an opposite side of the second board 630b. Each pair of pogo pins 610 includes a first pogo pin 610a and a second pogo pin 610b. Each pogo pin 610 can include a first end portion 612 configured to be electrically coupled to the rest of a circuit (e.g., as shown in FIG. 1) and a second end portion 614 opposite the first end portion 612.

Referring next to FIGS. 7A and 7B, the assembly 700 includes a first board 730a, six pairs of pogo pins 710 fixed to the first board 730a, a second board 730b, and six contact pads 720 attached to and exposed on the second board 730b. The first board 730a and the second board 730b can comprise concentric, generally circular boards made of epoxy, plastics, and/or other suitable insulating materials. Three of the six pairs of the pogo pins 710 are attached to one side of the first board 730a and the remaining three pairs of the pogo pins 710 are attached to an opposite side of the first board 730b. Similarly, three of the six contact pads 720 are attached to one side of the second board 730b and the remaining three contact pads 720 are attached to an opposite side of the second board 730b. Each pair of pogo pins 710 includes a first pogo pin 710a and a second pogo pin 710b. Each pogo pin 710 can include a first end portion 712 configured to be electrically coupled to the rest of a circuit (e.g., as shown in FIG. 1) and a second end portion 714 opposite the first end portion 712.

Referring to FIGS. 6A-7B together, during operation, the assemblies 600, 700 can switch between the OFF state (FIGS. 6A and 7A) and the ON state (FIGS. 6B and 7B) by rotating the first board 630a, 730a and/or the second board 630b, 730b along rotational direction R1 in either direction. In the OFF state, the second end portions 614, 714 of the pogo pins 610, 710 are not in contact with the corresponding ones of the contact pads 620, 720, but are instead in contact with the second board 630b, 730b. As previously mentioned, the boards can be composed of insulating or non-conductive materials such that current does not flow between the first pogo pins 610a, 710a and the second pogo pins 610b, 710b of each pair, resulting in an open circuit. In the OFF state, the second end portions 614, 714 of the pogo pins 610, 710 are in contact with corresponding ones of the contact pads 620, 720, resulting in a closed circuit that allows current to flow between the first pogo pins 610a, 710a and the second pogo pins 610b, 710b of each pair through the corresponding contact pad 620, 720. In some embodiments, individual ones of the pogo pins 610, 710 can include ball points to allow easier movement (e.g., sliding) of the second end portions 614, 714.

As similarly discussed above with reference to FIGS. 2A-5B, by having multiple pairs of pogo pins, the assemblies 600, 700 can provide multiple activation configurations. Additionally, or alternatively, the assemblies 600, 700 can provide a multiple redundancy arrangement to ensure completion of the electrical circuit when the assemblies 600, 700 are in the ON state. As illustrated in FIG. 1, the pairs of pogo pins 310 can be coupled to the rest of the electrical circuit in parallel such that as long as at least one pair of pogo pins properly contacts the corresponding contact pad, current can flow to complete the circuit. Although more components are required for the assembly 700 than for the assembly 600, the higher degree of redundancy can be more desirable in certain applications. A person skilled in the art will appreciate that a switch assembly in accordance with the present technology can include any number pairs of pogo pins and contact pads to provide any degree of redundancy, and can include the pogo pins and contact pads in different arrangements.

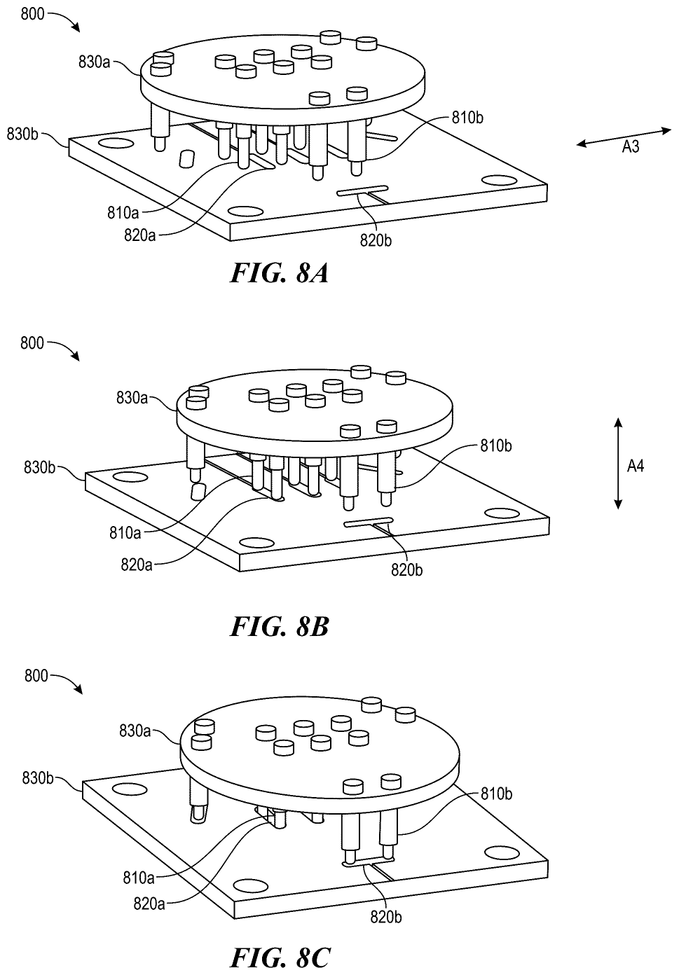

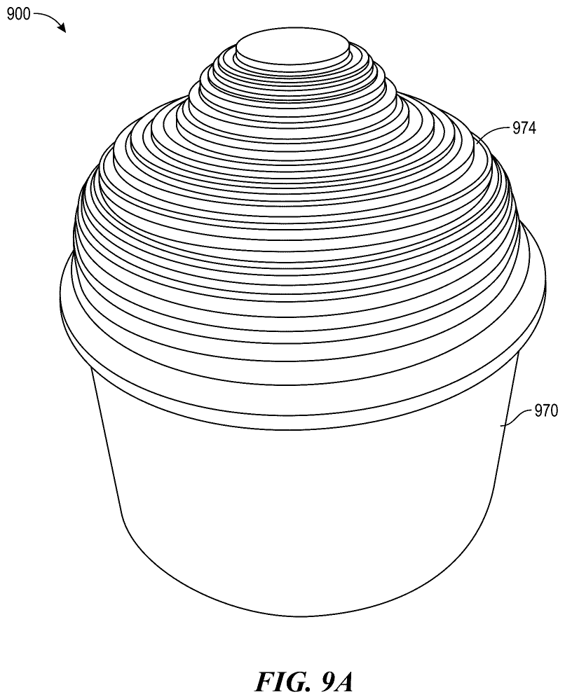

FIGS. 8A-8C are perspective views of a dual-axis redundancy switch assembly 800 (“assembly 800”) in accordance with embodiments of the present technology. Specifically, FIG. 8A illustrates the assembly 800 in an OFF state, FIG. 8B illustrates the assembly 800 in a partially ON state, and FIG. 8C illustrates the assembly 800 in an ON state. The assembly 800 can be an example of the switch assembly 100 illustrated in and described above with respect to FIG. 1. In the illustrated embodiment, the assembly 800 includes six pairs of pogo pins 810 supported on a first board 830a, and six contact pads 820 attached to and exposed on a second board 830b. As discussed further herein, the first board 830a and/or the second board 830b are movable in a lateral direction and toward or away from the other. In some embodiments, three of the pairs of the pogo pins 810 (one of which is labeled 810a) can extend longer toward the second board 830b when in the OFF state (FIG. 8A) compared to the other three of the pairs of pogo pins 810 (one of which is labeled 810b). Individual ones of the pogo pins 810 can include compression springs and/or ball points that allow the pogo pins 810 to compress or slide while maintaining contract with the respective contact pad, thereby maintaining electrical conductivity. Accordingly, the switch assembly 800 can provide a triple redundant slide or toggle switch incorporated with a pushbutton switch.

During operation, the assembly 800 can switch between the OFF state (FIG. 8A), the partially ON state (FIG. 8B), and the ON state (FIG. 8C) by moving the first board 830a and/or the second board 830b along a lateral axis A3 and/or a vertical axis A4. The boards 830a, 830b can be moved along the axes A3 and A4 in any order or move diagonally (along a vector sum of vectors extending along axes A3 and A4). In FIG. 8A, none of the pogo pins 810 are in contact with the corresponding ones of the contact pads 820. Specifically, a first set of three pairs (e.g., including pogo pin 810a) can be in contact with the second board 830b while a second set of three pairs (e.g., including pogo pin 810b) can remain at a distance from the contact pads 820 on the second board 830b, thus forming an air gap therebetween.

In FIG. 8B, which shows the assembly 800 after movement of the first and/or second board 830a, 830b along the axis A3 (e.g., via a lateral sliding motion), the first set of three pairs (e.g., including pogo pin 810a) are in contact with corresponding ones of the contact pads 820a while the second set of three pairs (e.g., including pogo pin 810b) can remain out of engagement with the corresponding contact pads 820b. In some embodiments, individual ones of the pogo pins 810 can include spring biased ball points to allow easier movement along axis A2.

In FIG. 8C, which shows the assembly 800 after movement of the first and/or second board 830a, 830b along the axis A4 (e.g., via a pushing motion), the first set of three pairs (e.g., including pogo pin 810a) remain in contact with the corresponding ones of the contact pads 820a while the second set of three pairs (e.g., including pogo pin 810b) can contact corresponding ones of the contact pads 820b. Specifically, internal compression springs within the first set of three pairs of pogo pins can become compressed as the boards 830a, 830b move toward each other along the axis A4 and the pogo pins 810 can move into engagement with the respective contact pads 820 to create electrical contact and to help prevent undesired lateral forces on the pogo pins 810, thereby minimizing potential damage to the pogo pins 810 and/or the contact pads 820. As discussed above, having multiple pairs of pogo pins 810 provides redundancy to the assembly 800 to insure proper operation of the switch assembly and to safeguard against performance malfunction.

In some embodiments, the first and second sets of three pairs can be coupled to two different circuits such that different devices are turned on or OFF independently and/or in a staggered manner. This can be advantageous in application in which space is limited and/or it is desirable to have a single switch assembly for controlling two or more different devices. For example, the assembly 800 can be coupled to both a heating element and a ventilator, FIG. 8B may correspond to turning on the heating element, and FIG. 8C may correspond to turning on the ventilator while keeping the heating element on.

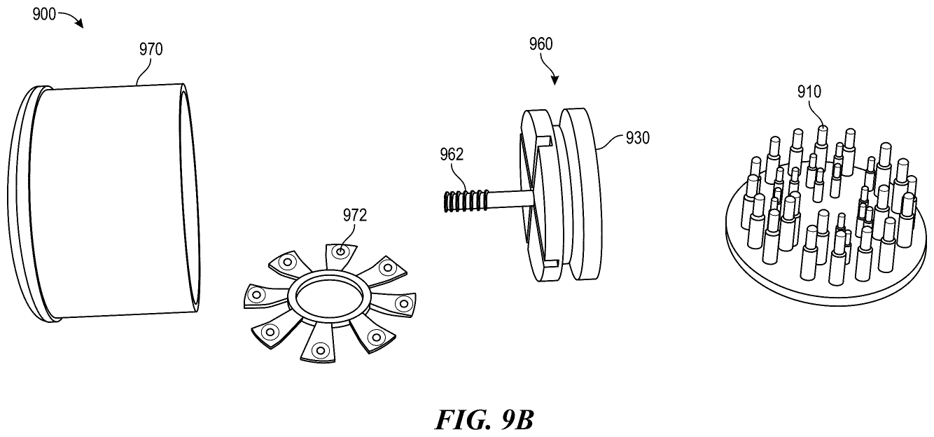

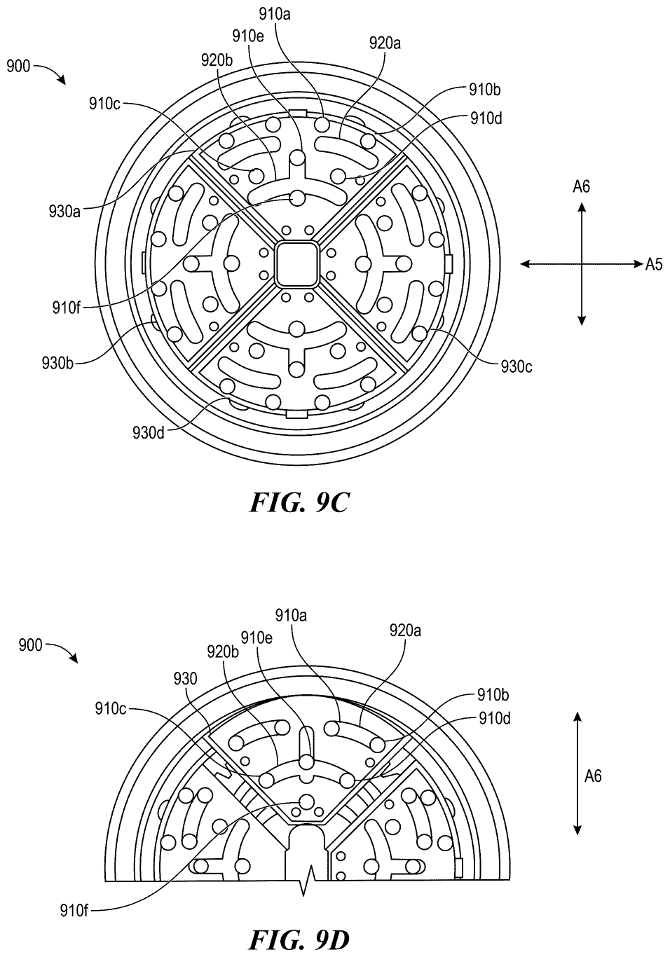

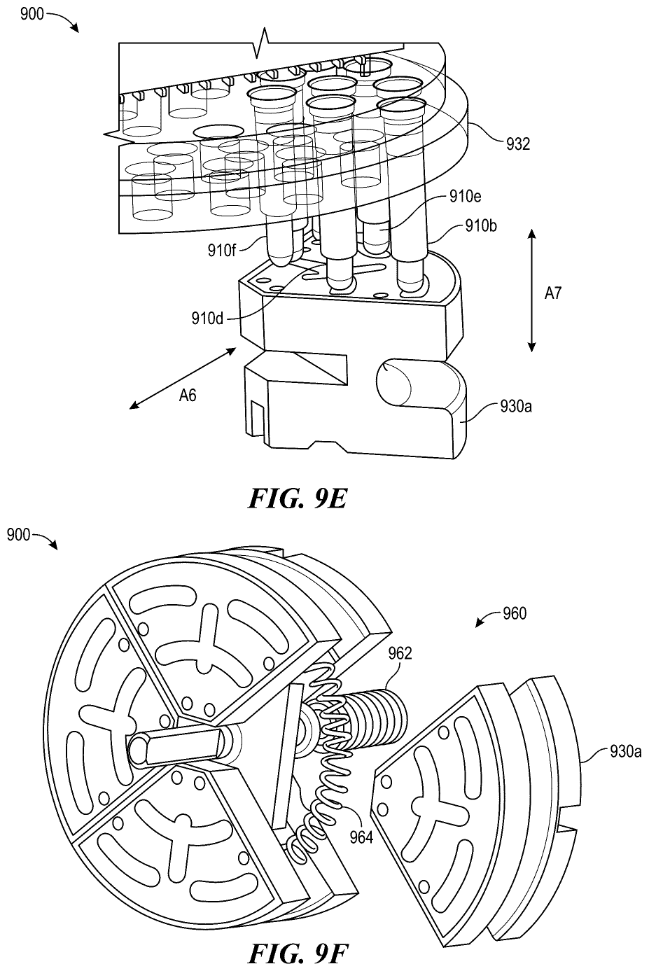

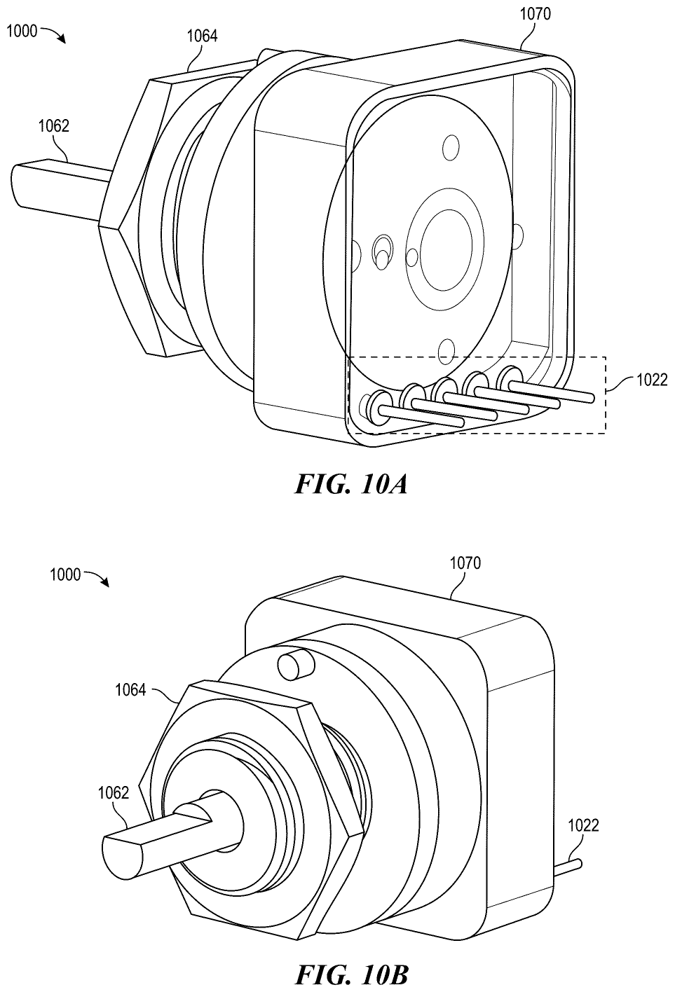

FIGS. 9A-9F illustrate a multi-directional sliding switch assembly 900 (“assembly 900”) in accordance with embodiments of the present technology. Specifically, FIG. 9A is a perspective view of the assembly 900 in an assembled configuration, FIG. 9B is a partially exploded view of the assembly 900, FIG. 9C is a plan view of the assembly 900 in an OFF state, FIG. 9D is a plan view of the assembly 900 in a first partially ON state, FIG. 9E is a perspective view of the assembly 900 in the first partially ON state, and FIG. 9F is a perspective view of the assembly 900 shown with a central portion 960. The assembly 900 can be an example of the switch assembly 100 illustrated in and described above with respect to FIG. 1.

Referring first to FIG. 9A, the assembly 900 includes a base 970 and a cap 974 that can define an enclosed space (e.g., a housing) in which other components of the assembly 900 can be stored. The base 970 and the cap 974 can protect and/or ensures proper actuation of the assembly 900. The base 970 and the cap 974 can also allow the assembly 900 to comprise a self-contained unit with a small footprint that can be coupled to various electrical devices. FIG. 9B shows the base 970, a détente spring 972, a central portion 960 having one or more board pieces 930 and a threaded shaft 962, and a plurality of pogo pins 910. Further details of these components are described below with reference to FIGS. 9C-9F.

Referring next to FIGS. 9C-9E together, the assembly 900 includes the plurality of pogo pins 910 (some of which are individually labeled 910a/b/c/d/e/f) on a board 932 (FIG. 9E), a plurality of contact pads 920 (two of which are individually labeled 920a and 920b), and a plurality of the board pieces 930a-d, wherein the contact pads 920 are attached to and exposed on the board pieces 930. Each of the board pieces 930 can be independently moved between a radially inward position (e.g., the board piece 930a in FIG. 9C) and a radially outward position (e.g., the board piece 930b in FIG. 9D). For example, first and fourth board pieces 930a, 930d can be individually moved along axis A6 while second and third board pieces 930b, 930c can be individually moved along axis A5 that is perpendicular to the axis A6. In the illustrated embodiment, each of the board pieces 930a-d is wedge-shaped.

When in the OFF state (FIG. 9C), none of the pogo pins 910 are in contact with any of the contact pads 920. Specifically, pogo pins 910a, 910b, 910c, 910d can be in contact with the board piece 930a (e.g., composed of an insulating material) while pogo pins 910e, 910f are separated from the board piece 930a by a gap or distance and out of contact with the respective contact pads 920, as better shown in FIG. 9E. When in the first partially ON state (FIGS. 9D and 9E), the board piece 930a has been moved along the axis A6 to allow pogo pins 910a, 910b to make contact with contact pad 920a, and to allow pogo pins 910c, 910d to make contact with contact pad 920b. The remaining pogo pins 910e, 910f can remain out of contact with their respective contact pads 920 (e.g., spaced apart, as shown in FIG. 9E), which opens that corresponding circuit or the portion of the circuit.

To configure the assembly 900 in a second partially ON state in which the pogo pins 910e, 910f are in contact with the contact pad 920b, the board piece 930a can be moved to the radially inward position illustrated in FIG. 9C and the board piece 930a and/or the board 932 can be moved along an axis A7 (FIG. 9E) that is perpendicular to both axes A5 and A6. However, when in the second partially ON state, because the board piece 930a is in the radially inward position, the pogo pins 910a, 910b, 910c, 910d may not be in contact with their corresponding contact pads 920. Therefore, the assembly 900 can simultaneously achieve redundancy (e.g., by having multiple ones of pogo pins 910a, 910b, 910c, 910d) while also physically ensuring that only a subset of the pogo pins complete their respective circuits at any given time. This can be useful for, e.g., an indicator with two light sources where only one light source must be on to convey a certain operating state of a device (e.g., a green light to indicate that there are no issues, a red light to indicate that there is an issue, and thus the green and red lights should never be on simultaneously). A first one of the light sources can be coupled to pogo pins 910a, 910b, 910c, 910d, while a second one of the light sources can be coupled to pogo pins 910e, 910f. Thus, the assembly 900 can physically ensure that fewer than all of the light sources are on at any given time or moment. Notably, the pogo pins 910c, 910d, 910e, 910f share the same contact pad 920b.

Referring next to FIG. 9F, each of the board pieces 930a-d can be coupled to the central portion 960. The central portion 960 can include a threaded shaft 962 to which a knob or other component (e.g., the activation member 20 in FIG. 1) can attach, and a spring 964 configured to keep the board pieces 930a-d together. In some embodiments, the spring 964 biases the board pieces 930a-d toward the positions shown in FIG. 9C. Returning to FIG. 9A, the détente spring 972 can provide a snap or click feedback (e.g., tactile and/or auditory) upon movement of the board pieces 930a-d.

FIGS. 10A and 10B are rear and front perspective views, respectively, of a multi-positional rotary switch assembly 1000 (“assembly 1000”) in accordance with embodiments of the present technology. Referring to FIGS. 10A and 10B together, the assembly 1000 can include a housing 1070, a shaft 1062 (e.g., a D-shaft), a bushing 1064, and a plurality of connection terminals 1022. For purposes of this discussion, a rear surface of the housing 1070 is shown partially transparent to illustrate select internal components of the assembly 1000 in FIG. 10A. The housing 1070 is configured to contain and protect various components of the assembly 1000. The shaft 1062 can be coupled to a knob or other component (e.g., the activation member 20 in FIG. 1) to mount the assembly 1000. The bushing 1064 can support the shaft 1062 relative to the housing 1070. The connection terminals 1022 can protrude out from the housing 1070 and can be electrically coupled to a circuit (e.g., the circuit in FIG. 1).

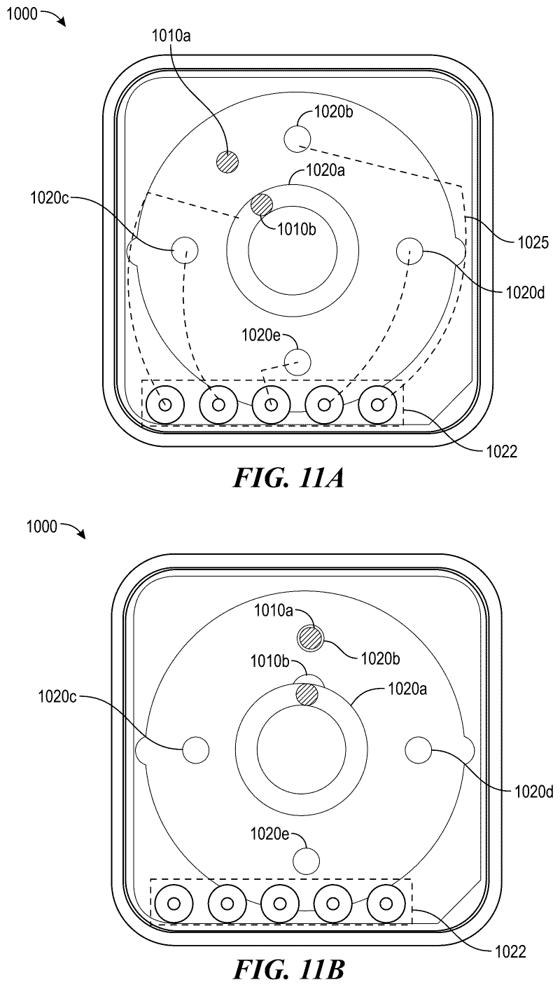

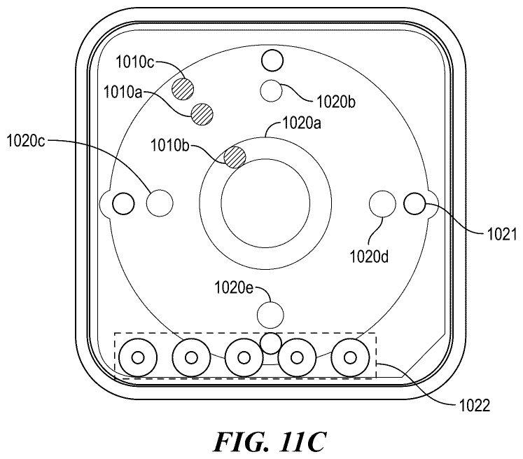

FIGS. 11A-11C illustrate operation of the assembly 1000 in accordance with embodiments of the present technology. Specifically, FIG. 11A is a plan view of the assembly 1000 in an OFF state, FIG. 11B is a plan view of the assembly 1000 in an ON state, and FIG. 11C is a plan view of another embodiment of the assembly 1000 with redundancy. The assembly 1000 can be an example of the switch assembly 100 illustrated in and described above with respect to FIG. 1. As discussed further herein, the assembly 1000 can be configured between an off state and multiple different on states.

Referring first to FIG. 11A, the assembly 1000 can further include a first pogo pin 1010a, a second pogo pin 1010b (collectively referred to as “the pogo pins 1010”), and a plurality of contact pads 1020, illustrated as five contact pads individually labeled 1020a/b/c/d/e. Each of the contact pads 1020 can be electrically coupled to a corresponding one of the five connection terminals 1022 via a corresponding connection path 1125. The two pogo pins 1010 can be electrically coupled to each other and can be configured to rotate together by rotating the shaft 1062 (e.g., by a person turning a knob coupled to the shaft 1062). The first contact pad 1020a is illustrated with an annular shape such that the second pogo pin 1010b always remains in contact with the first contact pad 1020a regardless of the angle at which the shaft 1062 is rotated. A person skilled in the art will appreciate that the contact pads 1020 can have different shapes. In some embodiments, each of the first and second pogo pins 1010a, 1010b can include ball points to allow easier movement.

Moreover, a first open circuit such as one including a first device (e.g., the device 50 of FIG. 1, not shown in FIGS. 11A-C) can be coupled between a first one of the connection terminals 1022 (the connection terminal coupled to the contact pad 1020a) and a second one of the connection terminals 1022 (the connection terminal coupled to the contact pad 1020b), a second open circuit such as one including a second device can be coupled between the first one of the connection terminals 1022 and a third one of the connection terminals 1022 (the connection terminal coupled to the contact pad 1020c), a third open circuit such as one including a third device can be coupled between the first one of the connection terminals 1022 and a fourth one of the connection terminals 1022 (the connection terminal coupled to the contact pad 1020d), a fourth open circuit such as one including and a fourth device can be coupled between the first one of the connection terminals 1022 and a fifth one of the connection terminals 1022 (the connection terminal coupled to the contact pad 1020e). As discussed further herein, the pogo pins 1010 can be rotated to selectively active one of the first through fourth devices. It is appreciated that in other embodiments, the assembly 1000 can include fewer or more contact pads 1020 and corresponding connection terminals 1022.

In FIG. 11A, the pogo pins 1010 are positioned such that the first pogo pin 1010a is not in contact with any of the contact pads 1020 (e.g., contacting a board instead) while the second pogo pin 1010b is in contact with the first contact pad 1020a. Therefore, the electrical circuit is open, current cannot flow through any of the devices coupled to the connection terminals 1022, and the assembly 1000 is in the OFF state. In FIG. 11B, the shaft 1062 has been rotated clockwise, such as by about 45 degrees, and the first pogo pin 1010 is shown in contact with the second contact pad 1020b while the second pogo pin remains in contact with the first contact pad 1020a. Therefore, current can flow through the first device by flowing through the first one of the connection terminals 1022 (coupled to the first contact pad 1020a) and the second one of the connection terminals 1022 (coupled to the second contact pad 1020b), and through the first and second pogo pins 1010 (since they are electrically coupled) to complete the first open circuit.

In the illustrated example, the second through fifth contact pads 1020b-e are arranged at approximately 90 degree intervals around the first contact pad 1020a such that the assembly 1000 is in the ON state when the shaft 1062 is rotated at any of the four right angles (e.g., 0 degrees, 90 degrees, 180 degrees, 270 degrees), as shown in FIG. 11B, and in the OFF state otherwise, as shown in FIG. 11A. A person skilled in the art will appreciate that the assembly can include any number of contact pads 1020 and connection terminals 1022, and that the contact pads 1020 can be arranged differently (e.g., at different angles).

FIG. 11C illustrates another embodiment of the assembly 1000 with redundancy. Specifically, the assembly 1000 is shown further comprising a third pogo pin 1010c and four redundant contact pads 1021, each disposed proximate or adjacent to a corresponding one of the second through fifth contact pads 1020b-e. The third pogo pin 1010c can be electrically coupled to the first and second pogo pins 1010a, 1010b. Each of the four redundant contact pads 1021 can be electrically coupled to the corresponding one of the second through fifth contact pads 1020b-e, and therefore to a corresponding one of the connection terminals 1022 as well. The third pogo pin 1010c and one of the four redundant contact pads 1021 can, when the shaft 1062 is rotated to an angle corresponding to an ON state, provide an additional current path for completing the circuit (hence redundancy) in case, for example, the first pogo pin 1010a and one of the second through fifth contact pads 1020b-e are misaligned.

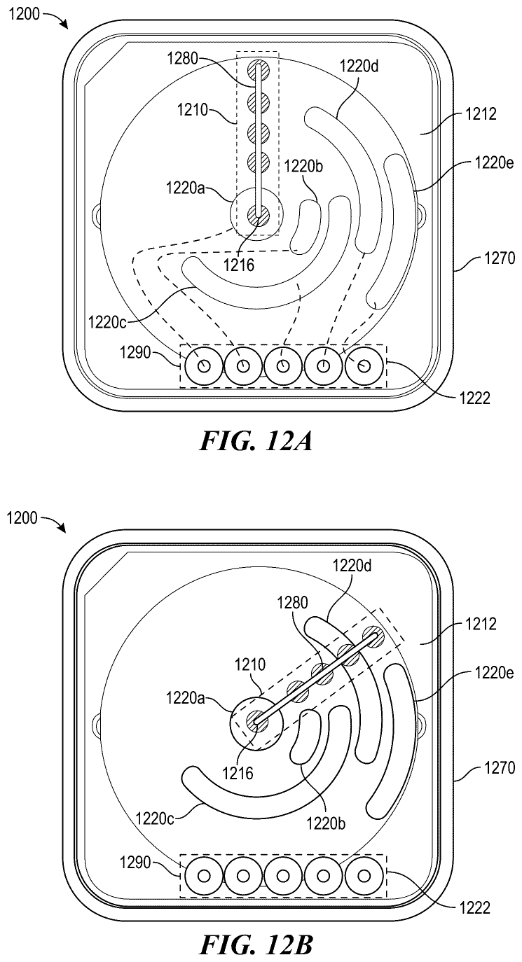

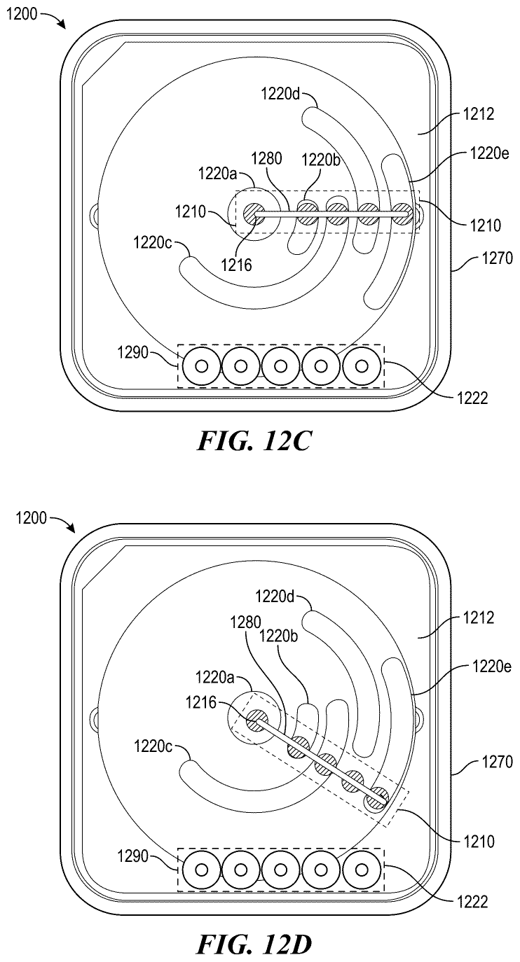

FIGS. 12A-12D are plan views of a binary code rotary switch assembly 1200 (“assembly 1200”) in accordance with embodiments of the present technology. The assembly 1200 can include a housing 1270 in which the electrical components of the assembly 1200 can be stored, and an activator 1280 coupled to and/or stored inside the housing 1270. The assembly 1200 can be an example of the switch assembly 100 illustrated in and described above with respect to FIG. 1. The illustrated binary code rotary switch assemblies can be self-contained units that occupy a constant and relatively small volume during operation, allowing the assemblies to be particularly advantageous in applications in which choosing an output among multiple outputs using a single input is desirable.

Referring to FIGS. 12A-D together, the assembly 1200 includes a plurality of pogo pins 1210 supported on a first board (not shown) and rotatably contained in the housing 1270 (e.g., the housing 10 in FIG. 1) and coupled to the activator 1280 that can be moved/activated manually or automatically. The assembly 1200 also has a plurality of contact pads 1220 (individually labeled 1220a/b/c/d/e) attached to and exposed on a second board 1212 fixedly retained in the housing 1270, such that the first board and pogo pins 1210 can move (e.g., rotate) within the housing relative to the second board 1212 and contact pads 1220, such as upon activation of the activator 1280. The assembly 1200 of the illustrated embodiment also includes a plurality of output terminals 1222 coupled to and extending out of the housing, each electrically coupled to a respective one of the contact pads 1220. In the illustrated embodiment, the pogo pins 1210 are arranged radially and linearly, and configured to rotate together about a pivot point 1216, which may be defined by a central shaft. All or subsets of the pogo pins 1210 can be electrically coupled to one another. The first contact pad 1220a remains always in contact with one of the pogo pins 1210. The second through fifth contact pads 1220b-e can have arched shapes of various lengths, and arranged about the pivot point 1216 at various radii and angles relative to the first contact pad 1220a. In other words, different ones of the second through fifth contact pads 1220b-e can extend across different angular ranges around the first contact contact pad 1020a and radially distal or proximal to one another. In some embodiments, one or more of the different angular ranges partially overlap. In the illustrated embodiment, the second board 1212 and the output terminals 1222 are in a fixed position relative to the housing 1270, and each contact pad 1220 can be electrically coupled to corresponding ones of the output terminals 1222. The output terminals 1222 can be operatively coupled to a processor 1290 or other system configured to receive and interpret the current readings to generate binary code outputs depending on the position and engagement of the pogo pins 1210 relative to the contact pads 1220, as will be described in further detail below.

FIGS. 12A-D illustrate the pogo pins 1210 at different positions or orientations relative to the contact pads 1220 corresponding to different switch positions. As the first board and the pogo pins 1210 rotate within the housing 1270 about the pivot point 1216 between a plurality of positions, the pogo pins 1210 move into positions for contact with one or more of the second through fifth contact pads 1220b-e, so as to complete a circuit and result in a binary code output of “1” corresponding to that particular contact pad 1220. Conversely, if one of the second through fifth contact pads 1220b-e is not in contact with the pogo pins 1210, that contact pad 1220 does not form part of the circuit and can result in a binary code output of “0” corresponding to that particular contact pad 1220. While the binary code configurations are described relative to outputs labeled as “0” and “1”, in other embodiment the relative positions of the pogo pins 1210 and the contact the contact pads 122 and associated outputs can use different labels analogous to the “0” and “1” labels used in this description. As mentioned above, the processor 1290 can be operatively coupled to each of the output terminals 1222 and can generate the binary code output.

In the illustrated embodiment, the processor 1290 may be CPU(s), GPU(s), HPU(s), etc. The processor 1290 can be a single processing unit or multiple processing units in a device or distributed across multiple devices. The processor 1290 can be coupled to other hardware devices, for example, with the use of a bus, such as a PCI bus or SCSI bus. The processor 1290 can communicate with a hardware controller for devices, such as for a display. Other I/O devices can also be coupled to the processor 1290, such as a network card, video card, audio card, USB, firewire, or other external device. The processor 1290 can have access to a memory in a device or distributed across multiple devices. A memory includes one or more of various hardware devices for volatile and non-volatile storage, and can include both read-only and writable memory.

Referring first to FIG. 12A, the assembly 1200 is shown in a first position in which the pogo pins 1210 are oriented and positioned such that only the first contact pad 1220a is in contact with a corresponding pogo pin 1210, and the other pogo pins are out of electrical engagement with the corresponding contact pads 1220. Therefore, the electrical circuit is open and current cannot flow from one contact pad 1220 to another and the switch's binary code output corresponding to each of the second through fifth contact pads 1220b-e can be 0.

In FIG. 12B, the pogo pins 1210 and first board are rotated clockwise in the housing about the pivot point 1216, so as to be oriented at a second position, for example, at approximately 45-degrees relative to the angle of the first position shown in FIG. 12A, such that the fourth contact pad 1220d is in contact with the corresponding pogo pin 1210. Therefore, in the switch's second position the binary code output corresponding to the fourth contact pad 1220d will be “1” while the binary code output corresponding to the second, third, and fifth contact pads 1220b, 1220c, 1220e will each be “0.”

In FIG. 12C, the pogo pins 1210 are further rotated clockwise about the pivot point 1216, so as to be oriented at a third position, for example at approximately 90-degrees relative to the angle of the first position shown in FIG. 12A, such that all of the contact pads are in contact with the pogo pins 1210. Therefore, the binary code outputs corresponding to the second through fifth contact pads 1220b-e will each be “1.”

In FIG. 12D, the pogo pins 1210 are further rotated clockwise about the pivot point 1216, so as to be oriented at a fourth position, for example at approximately 135-degrees relative to the angle shown in FIG. 12A, such that the second, third, and fifth contact pads 1220b, 1220c, 1220e are in contact with respective ones of the pogo pins 1210. Therefore, the binary code outputs corresponding to the second, third, and fifth contact pads 1220b, 1220c, 1220e will each be “1” while the binary code output corresponding to the fourth contact pad 1220d will be “0.”

The table below illustrates the example binary code outputs corresponding to each of FIGS. 12A-12D.

| | Binary Code Output of Contact | | | | |
|---|---|---|---|---|---|
| | Pad/Connection Terminal | | | | |
| | First | Second | Third | Fourth | Fifth |
| | Contact | Contact | Contact | Contact | Contact |
| Position | Pad | Pad | Pad | Pad | Pad |
| 1st (FIG. 12A) | 1 | 0 | 0 | 0 | 0 |
| 2nd (FIG. 12B) | 1 | 0 | 0 | 1 | 0 |
| 3rd (FIG. 12C) | 1 | 1 | 1 | 1 | 1 |
| 4th (FIG. 12D) | 1 | 1 | 1 | 0 | 1 |

The contact pads 1220 can be arranged on the second board 1212 in any predetermined pattern suitable for the desired application. A person skilled in the art will appreciate that the pogo pins 1210 can be rotated about the pivot point 1216 to other angles not illustrated, such as approximately 20-degrees relative to the angle of the first position shown in FIG. 12A in order to generate other binary code outputs. The assembly 1200 can also provide varying degrees of tolerance such as by arranging the contact pads 1220 such that the same binary code output is generated when the pogo pins 1210 are rotated to a position within a range of angles. For example, if the pogo pins 1210 are rotated 10-degrees clockwise from the position shown in FIG. 12C, the assembly 1200 may generate the same binary code output as when the pogo pins 1210 are at the position shown in FIG. 12C. In some embodiments, the assembly 1200 further includes a détente (e.g., the détente spring 972) configured to provide tactile and/or auditory feedback to a user (e.g., snapping into place) when the assembly 1200 is switched between different binary code outputs to indicate the same. In some embodiments, the assembly 1200 does not provide tactile feedback to a user, and instead provides a smooth transition between different angles.

A person skilled in the art will appreciate that the switch assemblies in accordance with the present technology can include arrangements of the pogo pins and contact pads with multiple possible positions so as to result in a wide range of other binary code outputs (i.e., different combinations of the “0” and “1” outputs). While the pogo pins 1210 and the contact pads 1220 are shown in a positionable relative to each other in essentially a circular arrangement relative to the pivot point 1216, the pogo pins 1210 and/or the contact pads 1220 can be arranged differently (e.g., different lengths, different angles, different relative positions) depending on the desired application. The binary code output generated by the assembly 1200 and the processor 1290 can be used to perform other actions. For example, the processor 1290 can be coupled to an external device, such as a lighting component (e.g., a lamp) and a user may rotate the assembly 1200 to different angles to change the color of the light, where different binary code outputs received by the processor 1290 correspond to different colors to be emitted by the lighting component. Although the above example is described in connection with a lighting component, the switch assemblies in accordance with the present technology can be used with processors coupled to other devices.

In some embodiments, the assembly 1200 can include redundancy by including another set of pogo pins (e.g., arranged along the same line as the illustrated pogo pins 1210, but on the other side of the center) and the contact pads 1220 can be duplicated on the other side of the board (e.g., duplicated after rotating the contact pads 1220 by 180-degrees).

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. It shall be understood that all aspects of the disclosure are not limited to the specific depictions, configurations, or relative proportions set forth herein, which depend upon a variety of conditions and variables. It should be understood that various alternatives to the embodiments of the disclosure described herein may be employed in practicing the disclosure. It is therefore contemplated that the disclosure shall also cover any such alternatives, modifications, variations, or equivalents. It is intended that the following claims define the scope of the disclosure and that methods and structures within the scope of these claims and their equivalents be covered thereby.

We claim:

1. A switch assembly, comprising:
a first board;
a plurality of contact pads attached to and exposed on the first board;
a second board spaced apart from the first board, wherein at least one of the first board or the second board is movable relative to the other to configure the switch assembly between an off state and an on state; and
a plurality of pairs of pogo pins attached to the second board, wherein each pair of pogo pins includes:
first end portions configured to be electrically coupled to an open circuit, and
second end portions opposite the first end portions,
wherein, in the off state, the second end portions of each pair of pogo pins are configured to not be in contact with any of the contact pads, and
wherein, in the on state, the second end portions of each pair of pogo pins are configured to be in contact with a corresponding one of the contact pads, thereby closing the open circuit.

2. The switch assembly of claim 1, wherein each pair of pogo pins is configured to provide redundancy so that when the switch assembly is in the on state, at least one of the plurality of pairs of pogo pins closes the open circuit.

3. The switch assembly of claim 1, wherein at least one of the first board or the second board is movable in a lateral direction so that the second end portions are configured to move between (i) a first position, corresponding to the off state, in which the second end portions make contact with the first board and (ii) a second position, corresponding to the on state, in which the second end portions make contact with corresponding ones of the contact pads.

4. The switch assembly of claim 1, wherein at least one of the first board or the second board is movable toward or away from the other so that the second end portions are configured to move between (i) a first position, corresponding to the off state, in which the second end portions are spaced apart from corresponding ones of the contact pads and (ii) a second position, corresponding to the on state, in which the second end portions make contact with the corresponding ones of the contact pads.

5. The switch assembly of claim 1, wherein at least one of the first board or the second board is rotatable with respect to the other so that the second end portions are configured to move between (i) a first position, corresponding to the off state, in which the second end portions make contact with the first board and (ii) a second position, corresponding to the on state, in which the second end portions make contact with corresponding ones of the contact pads.

6. The switch assembly of claim 1, wherein at least one of the first board or the second board is movable in a lateral direction and toward or away from the other so that the second end portions are configured to move between:
a first position, corresponding to the off state, in which second end portions of a first subset of the pogo pins make contact with the first board and second end portions of a second subset of the pogo pins are spaced apart from corresponding ones of the contact pads;
a second position, corresponding to a partially on state of the switch assembly, in which the second end portions of the first subset of the pogo pins make contact with corresponding ones of the contact pads and the second end portions of the second subset of the pogo pins remain spaced apart from corresponding ones of the contact pads; and
a third position, corresponding to the on state, in which the second end portions of the first and second subsets of the pogo pins make contact with the corresponding ones of the contact pads.

7. The switch assembly of claim 6, wherein the first subset of the pogo pins comprise ball point and spring-loaded pogo pins.

8. The switch assembly of claim 1, wherein the plurality of contact pads includes between two and six contact pads, and wherein the plurality of pairs of pogo pins includes between two and six pairs of pogo pins.

9. The switch assembly of claim 1, wherein a number of the contact pads is equal to a number of the pairs of pogo pins.

10. The switch assembly of claim 1, wherein the pairs of pogo pins are electrically coupled to the open circuit in parallel.

11. A switch assembly, comprising:
a plurality of board pieces each independently movable relative to one another;
a plurality of contact pads attached to and exposed on the plurality of board pieces;
a board spaced apart from the plurality of board pieces, wherein at least one of the plurality of board pieces or the board is movable toward or away from the other; and
a plurality of pairs of pogo pins attached to the board, wherein each pair of pogo pins includes:
first end portions configured to be electrically coupled to an open circuit, and
second end portions opposite the first end portions,
wherein the switch assembly is, for each of the board pieces, configurable between:
an off state in which none of the pogo pins make contact with the contact pads,
a first partially on state in which a first subset of the pogo pins make contact with corresponding ones of the contact pads, and
a second partially on state in which a second subset of the pogo pins make contact with corresponding ones of the contact pads.

12. The switch assembly of claim 11, wherein:
each of the board pieces is independently movable between a radially inward position and a radially outward position,
in the off state, the board piece is at the radially inward position and at least one of the board piece or the board is moved away from the other,
in the first partially on state, the board piece is at the radially outward position and at least one of the board piece or the board is moved away from the other, and
in the second partially on state, the board piece is at the radially inward position and at least one of the board piece or the board is moved toward from the other.

13. The switch assembly of claim 11, wherein:
in the off state, the first subset of the pogo pins make contact with the board piece and the second subset of the pogo pins are spaced apart from the board piece,
in the first partially on state, the second subset of the pogo pins are spaced apart from the board piece, and
in the second partially on state, the first subset of the pogo pins make contact with the board piece.

14. The switch assembly of claim 11, wherein, in the second partially on state, the first subset of the pogo pins are compressed against the board piece.

15. The switch assembly of claim 11, wherein, at any given moment, neither or only one of the first subset of the pogo pins or the second subset of the pogo pins make contact with corresponding ones of the contact pads.

16. The switch assembly of claim 11, wherein each of the board pieces is wedge-shaped.

17. The switch assembly of claim 11, wherein each of the board pieces is independently movable between a radially inward position and a radially outward position, and wherein the switch assembly further comprises a spring configured to bias each of the board pieces toward the radially inward position.

18. The switch assembly of claim 11, wherein at least one pair of the first subset of the pogo pins and at least one pair of the second subset of the pogo pins share a same one of the contact pads.

19. A switch assembly, comprising:
a first board;
a plurality of contact pads attached to and exposed on the first board, wherein the plurality of contact pads includes a first contact pad, a second contact pad, and a third contact pad;
a plurality of connection terminals, wherein the plurality of connection terminals includes:
a first connection terminal electrically coupled to the first contact pad,
a second connection terminal electrically coupled to the second contact pad, wherein the first and second connection terminals are configured to be electrically coupled to a first open circuit, and
a third connection terminal electrically coupled to the third contact pad, wherein the first and third connection terminals are configured to be electrically coupled to a second open circuit;
a second board spaced apart from the first board, wherein the second board is rotatable relative to the first board; and
a plurality of pogo pins attached to the second board and electrically coupled to one another, wherein the plurality of pogo pins includes:
a first pogo pin configured to remain in contact with the first contact pad as the second board rotates relative to the first board, and
a second pogo pin configured to move into and out of contact with the second or third contact pad as the second board rotates relative to the first board.

20. The switch assembly of claim 19, wherein the second board is rotatable relative to the first board to configure the switch assembly between:
an off state in which the second pogo pin contacts neither the second nor third contact pads;
a first on state in which the second pogo pin contacts the second contact pad, thereby closing the first open circuit; and
a second on state in which the second pogo pin contacts the third contact pad, thereby closing the second open circuit. 21 The switch assembly of claim 19, wherein the plurality of contact pads further includes a fourth contact pad, wherein the plurality of connection terminals further includes a fourth connection terminal electrically coupled to the fourth contact pad, wherein the first and fourth connection terminals are configured to be electrically coupled to a third open circuit, and wherein the second board is rotatable relative to the first board to configure the switch assembly between:
an off state in which the second pogo pin contacts none of the second, third, and fourth contact pads;
a first on state in which the second pogo pin contacts the second contact pad, thereby closing the first open circuit;
a second on state in which the second pogo pin contacts the third contact pad, thereby closing the second open circuit; and
a third on state in which the second pogo pin contacts the fourth contact pad, thereby closing the third open circuit.

22. The switch assembly of claim 19, wherein the first contact pad has an annular shape, and wherein the plurality of pogo pins are arranged around the first contact pad at a plurality of angular positions.

23. The switch assembly of claim 19, further comprising a plurality of redundant contact pads attached to and exposed on the first board, wherein the plurality of redundant contact pads includes:
a first redundant contact pad positioned adjacent to the second contact pad and electrically coupled to the second connection terminal; and
a second redundant contact pad positioned adjacent to the third contact pad and electrically coupled to the third connection terminal,
wherein the plurality of pogo pins further includes a third pogo pin configured to move into and out of contact with the first or second redundant contact pad as the second pogo pin moves into and out of contact with the second or third contact pad, respectively.

24. A switch assembly, comprising:
a first board;
a plurality of contact pads attached to and exposed on the first board, wherein the plurality of contact pads includes a first contact pad, a second contact pad, and a third contact pad;
a plurality of output terminals, wherein the plurality of output terminals includes:
a first output terminal electrically coupled to the first contact pad,
a second output terminal electrically coupled to the second contact pad, and
a third output terminal electrically coupled to the third contact pad;
a second board spaced apart from the first board, wherein the second board is rotatable relative to the first board;
a plurality of pogo pins attached to the second board and electrically coupled to one another, wherein the plurality of pogo pins includes:
a first pogo pin configured to remain in contact with the first contact pad as the second board rotates relative to the first board,
a second pogo pin configured to move into and out of contact with the second contact pad as the second board rotates relative to the first board, and
a third pogo pin configured to move into and out of contact with the third contact pad as the second board rotates relative to the first board; and
a processor coupled to the plurality of output terminals, wherein the processor is configured to generate a binary code output based at least in part on whether current is flowing through the second and/or third pogo pins.

25. The switch assembly of claim 24, wherein the second contact pad extends across a first angular range around the first contact pad, and wherein the third contact pad extends across a second angular range around the first contact pad and radially distal to the second contact pad.

26. The switch assembly of claim 25, wherein the first and second angular ranges partially overlap.
